(19) United States
(12) Patent Application Publication
(10) Pub. No.: US 2009/0132522 A1
(43) Pub. Date: May 21, 2009

(54) Systems and methods for organizing innovation documents

(76) Inventor: Sami Leino, Turku (FI)

Correspondence Address: Justin Reel, Suite 1580, 805 SW Broadway, Portland, OR, 97205, US

(21) Appl. No.: 12/252,304

(22) Filed: Oct. 15, 2008

Related U.S. Application Data
(60) Provisional application No. 60/960,898, filed on Oct. 18, 2007.

(51) Int. Cl. G06F 17/30

(52) U.S. Cl. 707/5; 707/E17.008; 707/E17.017

(57) ABSTRACT

A system and method for innovation documents is disclosed. A database stores an innovation classification system, ontology, synonym vocabulary and fill word list plus prior innovation descriptions. An innovation document, describing a new innovation is received and processed (3-2), including identifying key words by ignoring fill words (3-4); using the synonym vocabulary (3-6) and ontology (3-10) to produce (3-12) a systematized innovation document; weighting (3-14) the key words of the systematized innovation document by mapping its key words against the innovation classification system (3-16); determining an optimal placement (3-18) for the innovation document in the innovation classification system based on the weights; and outputting the optimal placement and at least part of the innovation classification system.

### FIELD OF THE INVENTION

The invention relates to generally to computerized systems and computer-assisted methods for organizing electronic innovation documents and particularly to systems and methods which support classification of innovation documents. As used herein, the term “computer” and its derivatives like “computerized” or “computer-assisted” refer to automated or mostly automated processing by electronic data processing equipment. An innovation document means a computer-readable description of an innovation, wherein the computer-readable description resides in a physical storage medium, which may comprise electronic, optical or magnetic storage or any combination thereof. A non-exhaustive list of types of innovation documents includes patents, patent applications, reissue patents or similar rights, such as utility models or short-term patents, and invention reports which have not yet been filed as patent applications.

### BACKGROUND OF THE INVENTION

Classification of innovations is a laborious undertaking which is further hampered by the fact that different entities use different names for similar items. For example, a network element called “mobile switching center” might be called “mobile terminal switching office” or “mobile network switching office” by others. Another example is “memory” or “storage” which are often used interchangeably. Another problem is that different entities use terminology from various taxonomical levels when referring to substantially similar items, such as “computer”, “data processor” or “data processing means”. Because innovation documents are poorly structured and use non-systematic and inconsistent terminology, classification of innovations is difficult to automate, even partially. The poor support by automation brings about the further problem that patent classification systems are updated rarely, and many rapidly evolving fields must cope with patent classification systems in which even the most detailed level of classification includes innovations which are completely unrelated to one another. For example, in International Patent Classification (“IPC”), sixth edition (1994), IPC Class G06F 17/60 encompassed all data processing equipment or methods for administrative, commercial, managerial, supervisory or forecasting purposes. In the next (2006) revision of the IPC system, class G06F 17/60 was moved to G06Q and subdivided into a finer-grained scheme. Such revised classification schemes force patent examiners and/or in-house portfolio manager to re-classify existing patents and related documents. Nevertheless, the IPC system revised in 2006 comprises a class (G06Q 30/00) which is common for all inventions relating to “commerce, eg marketing, shopping, billing, auctions or e-commerce” or another class (G06Q 50/00) which is common for all inventions relating to “systems or methods specially adapted for a specific business sector, eg health care, utilities, tourism or legal services”. This means that queries for innovations related to “data processing systems or methods for health care” by their patent class, obtain, return overwhelming numbers of irrelevant innovations. Therefore it is extremely difficult to avoid accidentally infringing existing patents or related rights.

### BRIEF DESCRIPTION OF THE INVENTION

An object of the invention is to provide systems and methods for alleviating one or more of the above-identified problems. The object is achieved by systems and methods which are stated in the attached independent claims. The dependent claims and the following description and drawings relate to specific embodiments of the invention.

An aspect of the invention is a computer-assisted method for supporting organization of innovation documents, comprising:

maintaining a database in a physical storage medium;

storing in the database at least one computer-readable description for each of the following: an innovation classification system, an ontology, a synonym vocabulary and a list of fill words;

storing in the database a plurality of computer-readable innovation descriptions;

receiving a computer-readable innovation document which describes an innovation;

processing the computer-readable innovation document, wherein said processing of the computer-readable innovation document is responsive to said reception of the computer-readable innovation document and comprises:
identifying key words of the computer-readable innovation document by mapping the computer-readable innovation document against the list of fill words;
producing a systematized version of the computer-readable innovation document by mapping the key words of the computer-readable innovation document against the computer-readable synonym vocabulary and the computer-readable ontology;
producing a weighting for each key word of the systematized version of the computer-readable innovation document by mapping its key words against the computer-readable innovation classification system;
determining an optimal placement of the innovation document in the innovation classification system based on the weightings for the key words; and
outputting the optimal placement of the innovation document and at least part of the innovation classification system to a physical output device.

Another aspect of the invention is a computer system comprising means for carrying out the above method. Yet another aspect is a software medium comprising program code instructions whose execution in the computer system causes the computer system to carry out the above method.

As used herein, an innovation document is a computer-readable document which describes an innovation. Computer-readable means that a computer system can extract individual words and phrases from the innovation document without resorting to optical character recognition techniques, or the like. An illustrative but non-restrictive example is a text or word processing document which may be similar to a patent claim or a set of claims including independent and dependent claims.

The term innovation description is used to refer to descriptions of innovation which are previously stored in a database.

The innovation classification system indicates a class for each innovation as well as a relation of the classes to one another. The innovation classification system may be implemented as tree structure comprising a root node, intermediate nodes and leaf nodes, and its starting point may be an existing patent classification system, such as the IPC. Because of the problems described earlier, it is beneficial to update and complement the innovation classification system in response to a detection that one or more nodes become too crowded. This means that one or more of the nodes contain such a large number of innovations that placing an innovation to such a crowded node provides little indication as relates to the industry sector of the innovation. For example, in the 1994 version of the IPC, virtually all computer-implemented business applications were placed in class G06F 17/60, and the problem still persists, as described in the background section of this document.

Fill words refer to words, phrases and expressions which are too common to describe any particular innovation, such as articles, particles, prepositions, and very ubiquitous words like “method”, “apparatus” or “comprising”. The fill words may be indicated by a computer-readable list of previously stored fill words. The words that remain in the innovation document after the fill words have been eliminated or ignored are called key words.

The synonym vocabulary provides more common replacements to less common words, phrases or expressions. The ontology provides replacements at different levels of generalizations.

The purpose of the systematized version of the innovation document is to eliminate some of the confusion caused by the use of synonyms and expressions at different levels of generalization.

The weights may be assigned based on the frequency of each key word in the innovation document and/or the relative location of each key word in the innovation document. A key word which occurs five times in the innovation document is probably relevant, and should be weighted more heavily, than a key word occurring only once. Alternatively or additionally the weights may depend on the relative location of each key word in the innovation document. For instance, key words closer to the end of the innovation document may be weighted more heavily than key words farther from the end because it is common practice that the ends of innovation documents (such as patent claims) describe end products or results of the method or apparatus, while words more distant from the end describe intermediate products or results.

The key words of the innovation document and the weights assigned to them are used to determine an optimal placement for the innovation in the innovation classification system. The expression “optimal placement” means subjectively optimal, ie, a placement which best describes the class (category) of the innovation based on an computerized classification process. It is quite possible that a human user, with a deeper understanding of the innovation, may classify the innovation better than a computer does, and such a classification might be called “objectively optimal”. On the other hand, the invention may be used in a partially computer-assisted mode, wherein a human user determines the innovation's IPC class which serves as a starting point for the placement in the innovation classification system, and the computer-implemented process then fine-tunes that classification into a finer-grained tree node, as a result of the frequency and relative locations of the key words in the innovation document.

In one specific embodiment, the weighting for each key word is at least partially based on a location of the key word within the innovation document. This embodiment is based on the realization that in many innovation documents, particularly granted patents, key words near the end of the independent claims should be weighted more heavily than key words closer to the beginning of the independent claims. This is because key words near the end of the independent claims frequently define the end result of the claimed process or system, whereas key words closer to the beginning usually relate to intermediate results.

Another specific embodiment comprises determining a degree of correspondence between the innovation document and one or more of the innovation descriptions stored in the database.

A high degree of correspondence between the innovation described by the innovation document and one or more of the innovation descriptions previously stored in the database indicates a higher-than-average likelihood that the inventions are similar. For instance, assuming that the innovation classification system is presented as a tree structure including a root node, intermediate nodes and leaf nodes, the degree of correspondence may be determined on the basis of the number of common nodes, particularly number of common leaf nodes, between the innovation described by the innovation document and an innovation description stored in the database. Instead of the number of common nodes or leaf nodes, or in addition to such a number, the degree of correspondence may be based on the number of common strongly-weighted key words.

An illustrative but non-restrictive application example of the present invention is a computer-assisted novelty search in respect of the innovation document, which may be a claim or a set of claims in an application for a patent or related right. The optimal placement of the innovation document is determined on the basis of the frequency and relative locations of the key words, as described earlier, and then any previously-stored innovation description having the same placement has a higher-than-average likelihood of describing the same or similar innovation, and such similarly-placed innovation descriptions are candidates for prior art references.

In another illustrative mode of utilizing the invention, the innovation document describes a prospective new product or service. In this scenario, a high degree of correspondence between the innovation described by the innovation document and an innovation description stored in the database serves as an indication that the new product or service may infringe the patent right resulting from the innovation description stored in the database.

Yet another specific embodiment comprises filtering the innovation descriptions stored in the database by one or more filters. Technically speaking, such filters may be implemented as criteria for queries to the database. Such filters may be used to generate filtered (restricted) sets of the innovation descriptions stored in the database. For instance, an infringement analysis may use filtering to restrict the analysis to innovations of a given owner (assignee). Filtering may also focus processing to innovations relating to a specific industry sector which, in turn, may be determined by the placement of the innovations in the innovation classification system. For this feature, an innovation classification system modelling the International Patent Classification, or based on it, is better than the one normally used in the United States because the IPC system more accurately reflects intended use while the latter focuses on implementation details regardless of intended use.

The above-described infringement analysis used filtering to find patents which are potentially infringed by a product or service described in an innovation document. But after creation of the database with the inventive innovation classification system, filtering may be used even when it does not relate to any particular innovation document. Examples of filters for such purposes include filters by owner or inventor. Yet further examples include filters by time. For example, the filtering may be used to determine the number of patent applications filed in any given industry sector in any given period of time. Visualization techniques may be used to present an animated (time-dependent) development of patent applications per owner or industry sector.

Yet another mode of utilizing the invention relates to a duty to provide the USPTO with a declaration of patent applications which are sufficiently similar to form a family of applications. Applicants with large numbers of patent applications may utilize the invention in a company-internal database containing innovation descriptions of the company's own patent applications.

### BRIEF DESCRIPTION OF THE DRAWINGS

In the following the invention will be described in greater detail by means of specific embodiments with reference to the attached drawings, in which

FIG. 1 shows a general overview of a representative computer system in which the invention can be used;

FIGS. 2A through 2C illustrate exemplary implementations for the various data structures used in the invention;

FIG. 3A shows a method according to an embodiment of the invention;

FIG. 3B illustrates eliminating fill words from an exemplary patent document;

FIG. 4A shows an invention classification system as a node tree structure;

FIG. 4B illustrates using the node tree structure shown in FIG. 4A as an innovation relevance structure;

FIG. 4C illustrates using the innovation relevance structure shown in FIG. 4B as an innovation reflection structure, which indicates correspondence between two (or more) innovations;

FIG. 5A illustrates visualization of innovation build-up per industry sector;

FIG. 5B illustrates comparing the numbers of patents or patent applications of multiple owners;

FIG. 5C illustrates visualizing the number of patents or patent applications for a single owner;

FIG. 5D illustrates visualization of nodes places at different times; and

FIG. 5E illustrates zooming or interactive partial magnification of a section of the innovation classification system.

### DETAILED DESCRIPTION OF SPECIFIC EMBODIMENTS

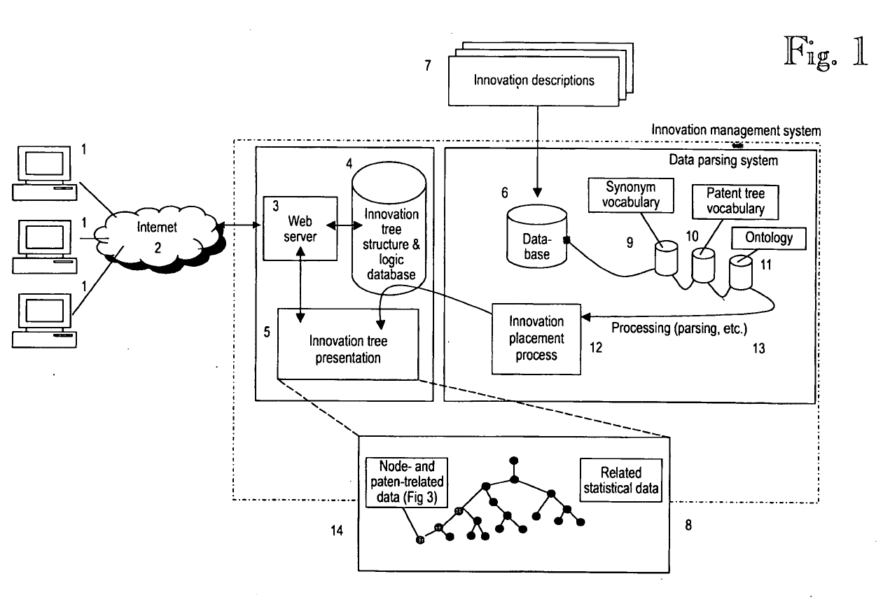

FIG. 1 shows a general overview of a representative computer system in which the invention can be used. Such a computer system can be used to provide the various services made possible by the present invention and its embodiments, such as patent placement, mapping and search service.

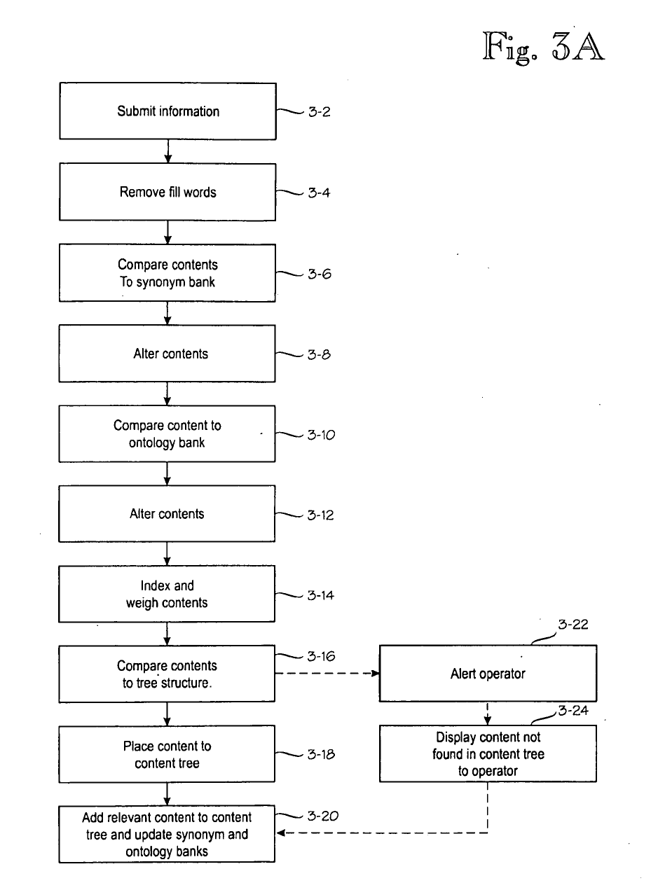

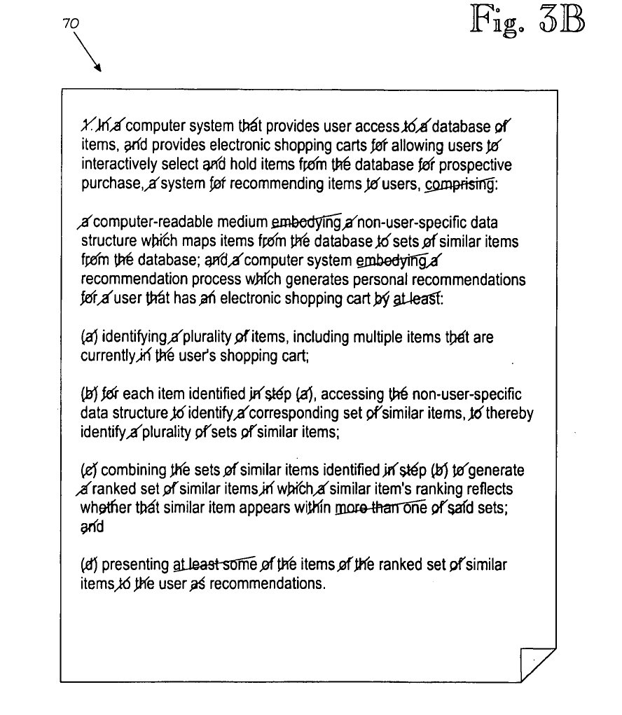

Arrows illustrate information flow between the various components of the computer system. Services may be provided via a data network 2, such as the internet, to terminals 1 (eg dedicated terminals or general-purpose computers with internet browser software). Reference numeral 3 denotes a web server which acts as a gateway between the terminals 1 and data network 2 on one hand and the computer system of the invention on the other hand. The web server 3 is able to provide presentations 5 of the innovation classification system tree structure residing in a computer-readable database 4. The innovation tree may be viewed with innovations mapped to the innovation tree, as indicated by reference numeral 14. In addition, statistical data may be presented, as denoted by reference numeral 8. Innovation descriptions 7 are submitted to a computer-readable innovation database 6. Processing of innovation descriptions and innovation documents involves the use of synonym vocabulary 9, patent tree vocabulary 10 and ontology 11. Reference numeral 13 denotes processing of an innovation document, as will be described in more detail in connection with FIGS. 3A and 3B. Results of such processing may be used in a patent placement process 12 and onwards in the presentation 5.

Within the context of the present invention, the terms “innovation description” and “innovation document” are used as follows. Each innovation description, generally denoted by reference numeral 7, is a description of an innovation stored in the innovation database 6. An exemplary but non-exhaustive list of innovations includes patents, utility models, short-term patents, design patents, or applications of such rights, technical documents usable as prior art references, etc. The term “innovation document”, an example of which will be shown in FIG. 3B, refers to a computer-readable description of a single invention which is to be mapped against the innovation descriptions previously stored in the database 6. As a rough analogy, the innovation document corresponds to a patent application (or a claim of a patent application) being examined, while the plurality of innovation description 7 correspond to all the prior art stored previously in a patent office.

If the operator of the computer system is a national or multi-national patent office, or a supplier of patent search services, the operator already has such a database; other operators may build up the innovation database 6 by downloading or wholesale purchasing of patent data from patent offices or the like.

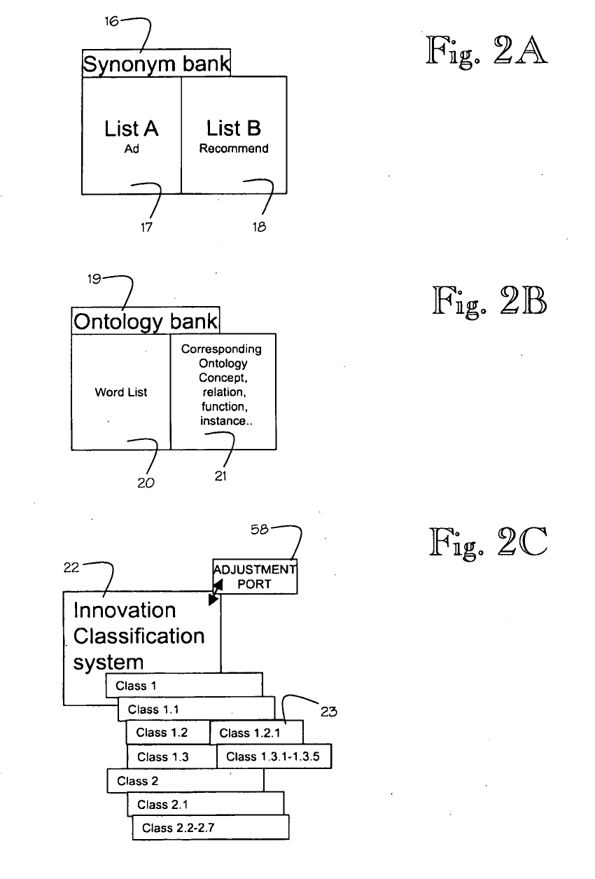

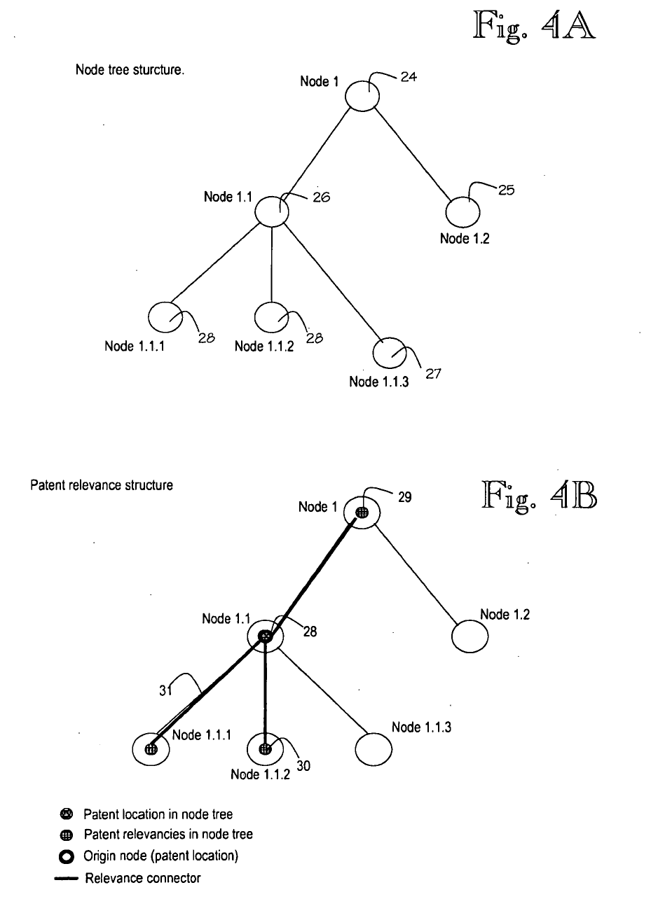

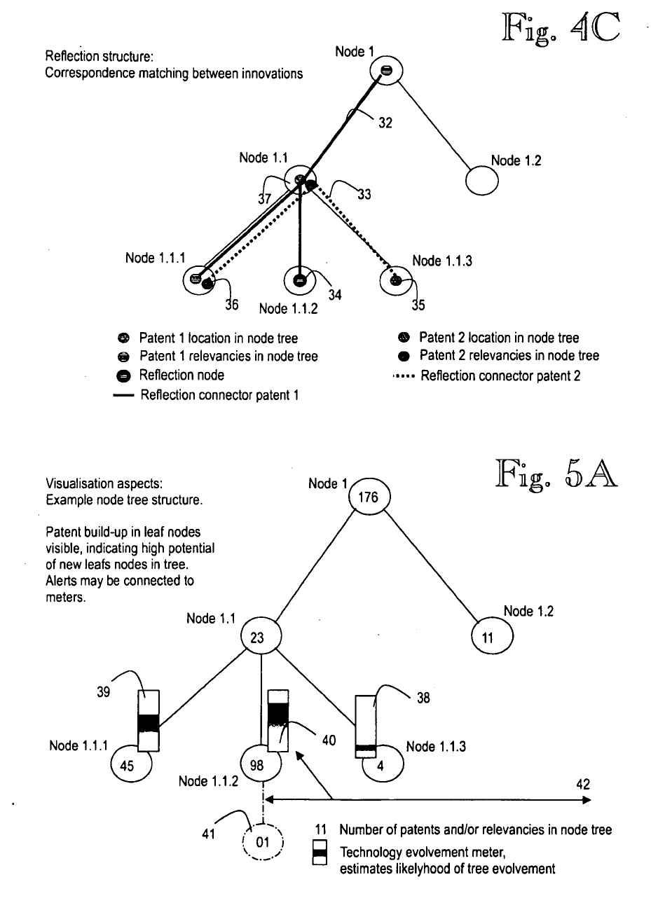

FIGS. 2A through 2C illustrate exemplary implementations for the various data structures used in the invention. Synonym bank 16 is grossly analogous to a computerized dictionary. However, the synonym bank 16 differs from a dictionary in that a dictionary usually provides multiple alternatives for a single look-up word or phrase, while the synonym bank 16 provides a common alternative word or phrase for multiple words or phrases. With an appropriate software look-up routine, the synonym bank 16 is used to change words or phrases to their commonly-used synonyms. For example, the left-hand section 17 might contain an entry for “mobile telephone switching office”, while the right-hand side provides the alternative term “mobile switching center” (or vice versa, depending on which term or phrase is regarded as the most commonly used one). Ontology bank 19 contains section of parsed wordings 20 and corresponding ontology definitions 21. The ontology 19 is used in a manner which is somewhat analogous with the manner the synonym bank 16 is being used, but the ontology bank 19 provides alternative terms at different taxonomical levels (different levels of generalization). For instance, the ontology bank 19 may be used to convert a specific term like “GSM” to a more generic term like “cellular mobile system”. Innovation classification system 22 defines categories (classes) 23 of patents. In one specific embodiment, the computer system shown schematically in FIG. 1, may include an adjustment port 58 which opens the innovation classification system 22, including the class structure 23, to modifications by third parties, such as users from the user community. Such users may be authorized or non-authorized, as desired. This practice is analogous to the manner in which the Wikipedia dictionary and related wiki-based services are updated. Implementation examples of the innovation classification system 22, 23 will be provided in connection with FIGS. 4A through 4C.

FIG. 3A shows a method according to an embodiment of the invention. In step 3-2, a user requests the computer system to process an innovation document. In step 3-4, the computer system removes fill words, such as articles, prepositions, particles, claim and step numbering and certain words or phrases which are too common to be specific to any particular innovation. Examples of such common words or phrases are “method”, “apparatus”, “comprising”, “including”, “embodying”, “at least one”, or the like. An example of an innovation document with fill words eliminated will be presented in connection with FIG. 3B. In step 3-6, the computer system compares the remaining contents (key words) of the innovation document with the synonym bank 16, and in step 3-8 it replaces some of the words, terms or phrases by their more common counterparts. In optional steps 3-10 and 3-12, a similar process is carried out by using the ontology bank 19. After step 3-8, and steps 3-10 and 3-12 if executed, the computer system has generated a systematized version of the innovation document. The underlying idea of the systematized version of the innovation document is that, while different persons might describe the same invention by different terms, the systematized versions of different innovation documents in respect of the same invention will eliminate at least some of the differences.

In step 3-14 the computer system indexes the key words in the innovation document and assigns a weight to them. For instance, the weight to a key word may be assigned based on the relative location of the key word in the innovation document. In step 3-16, the key words and weights are compared with the innovation classification system 22. As a result of the comparison, the computer system can determine an optimal placement for the innovation document in the innovation classification system 22. The subsequent acts shown in FIG. 3A relate to different use cases. For instance, the optimal placement for the innovation document in the innovation classification system may be outputted to a physical output device, such as a display or printer. Alternatively or additionally, the innovation document and/or its optimal placement may be stored in the innovation database 6.

FIG. 3B illustrates a process of eliminating fill words from an exemplary innovation document. In the example shown in FIG. 3B, reference numeral 70 denotes an innovation document, which by way of example, happens to be claim 1 of U.S. Pat. No. 6,317,722. Overstriking indicates fill words which are too common to be specific to any particular innovation. The fill words (and phrases) can be determined by mapping each word against a computer-readable list of fill words (not shown separately).

The particular example shown in FIG. 3B uses words which are very commonly used, which is why this particular example does not benefit much of the processing via the synonym bank 16. But the synonym bank could be used to change “generate” to “provide”, “recommendation” to “advertisement”, “ranked” by “sorted”, “reflect” by “indicate”, or the like.

FIG. 4A shows an invention classification system as a node tree structure 24. As shown by reference numeral 26, the nodes are connected to one another according to the innovation classification system 22. The nodes may have patent processing related information 25 attached to them. The nodes are placed in such a manner that each node can be visualized in a place which reflect the time when the node was placed to tree 27. If a new node is inserted to the tree later than an older node, the new node may be placed lower in the tree than the older node.

FIG. 4B illustrates using the node tree structure shown in FIG. 4A as an innovation relevance structure;

FIG. 4B illustrates a patent 28 placed on the innovation classification system 22, as defined by classification system hierarchy 23. As denoted by reference numeral 28, the patent is placed on innovation classification system location node 1.1. The patent 28 relates to nodes 1, 1.1.1 and 1.1.2. Patent relations define relating contents of the patent.

FIG. 4C illustrates using the innovation relevance structure shown in FIG. 4B as an innovation reflection structure, which indicates correspondence between two (or more) innovations. FIG. 4C illustrates two patents, denoted by reference numerals 37 and 35, superposed on a section of the innovation classification system 22. A first patent, denoted by reference numeral 37, has relevancies also in nodes 1, 1.1 and 1.1.2. A second patent, denoted by reference numeral 35, has relevancies in node 36 which is a leaf node and in the node within the same patent. When the user selects node 1.1.2, which indicates one or more patents (or sections of patents), the computer system provides the user with an indication of all patents which are connected to nodes wherein one of the selected patents have relevancies. In context of the present invention, such indication is called reflection. As shown by reference numeral 32, connections of each patent may be displayed visually.

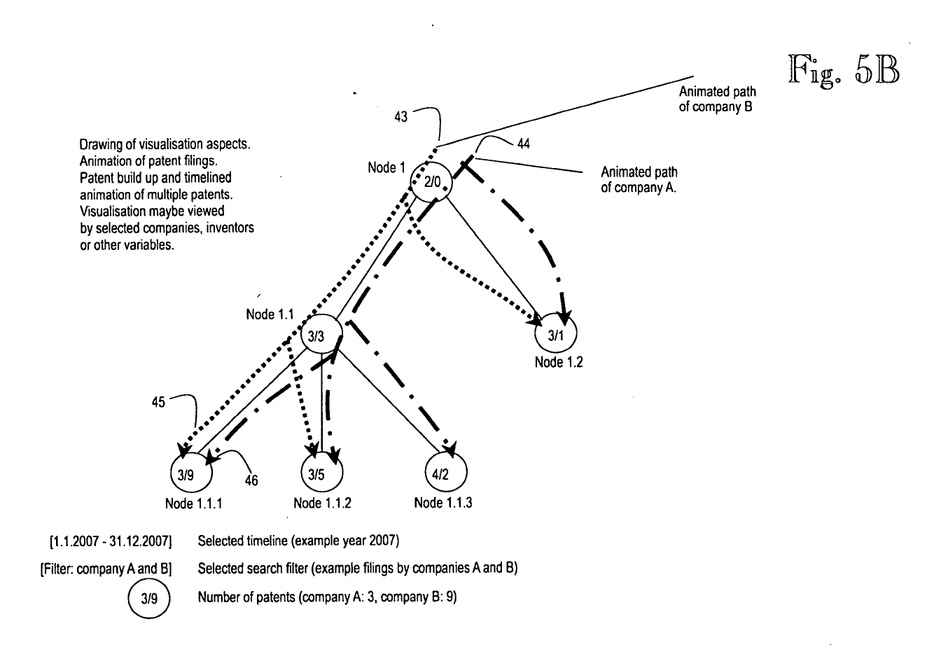

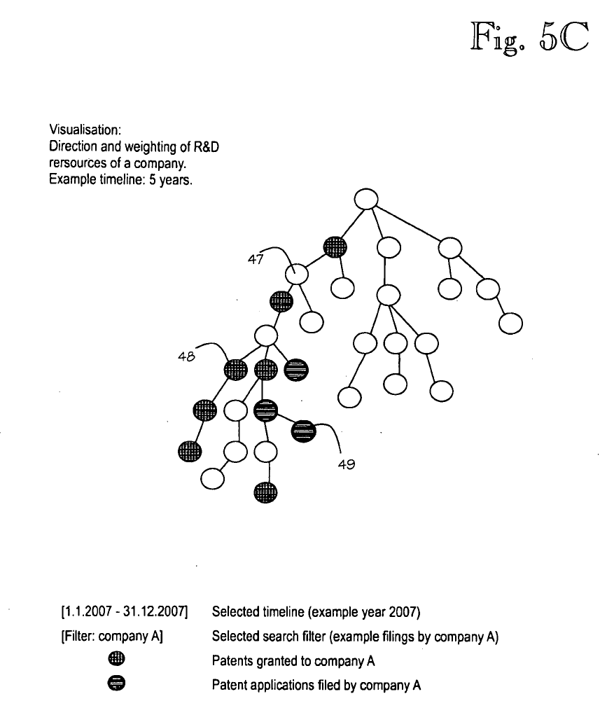

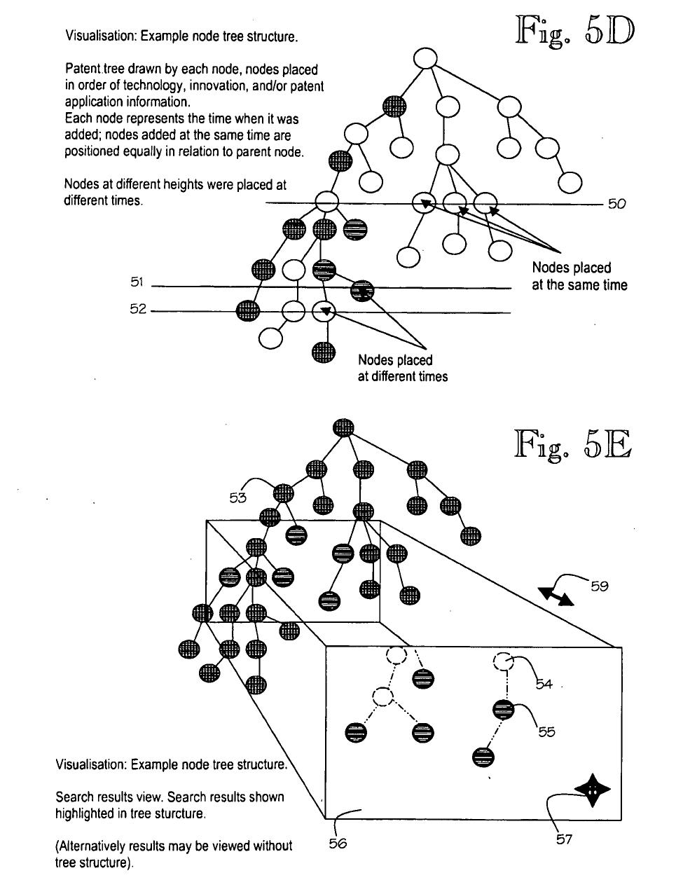

FIG. 5A illustrates visualization of innovation build-up per industry sector. FIG. 5A shows nodes 1.1.1, 1.1.2 and 1.1.3 with measures 38, 39, 40 measuring the number of patents corresponding to each node. In FIG. 5A the meters are shown as bar graphs wherein a 100% reading indicates some predetermined number of innovations connected to the node in question. The number may be absolute, wherein exceeding that number may trigger an alert that the node (“innovation class”) in question should be subdivided into finer-grained nodes, or the number may be relative, for example such that the node with the highest number of innovations has a reading of, say, 100%, wherein the task of subdividing nodes should be focused to nodes with the highest readings.

Depending on the number of patents corresponding to each node, their relevancies and the timeline in which they were filed, the measures 38, 39 may be used to signal a need to insert new nodes 41 to innovation classification system 22. Such new nodes may be placed by the operator of the computer system and/or by users in the user community, as illustrated by item 58 in FIG. 2C.

FIG. 5B illustrates comparing the numbers of patents or patent applications of multiple owners. FIG. 5B shows two groups of patents, denoted by reference numerals 45 and 44, placed on the innovation classification system 22. The patents selected to be presented at once or in sequence reflect the position and order of filings. By displaying selected patents chronographically as an animation, the users may obtain a better understanding of the invention process relating to the selected patents in a specific area of the innovation classification system.

FIG. 5C illustrates visualizing the number of patents or patent applications for a single owner. In FIG. 5C reference numeral 47 shows a selected section of nodes from a selected portion of the timeline. The selected section of nodes 47 is placed on the innovation classification system 22. Pending patent applications 49 and granted patents 48 may be presented visualized separately.

FIG. 5D illustrates visualization of nodes places at different times. All nodes at the same height, such as all the nodes traversed by line 50, were inserted to the innovation classification system at the same time. On the other hand, reference numerals 51 and 52 denote different timelines, such that nodes traversed by timeline 51 were place in the innovation classification system later than the nodes traversed by line 50 but earlier than nodes traversed by line 52.

FIG. 5E illustrates zooming (interactive partial magnification). Reference numeral 53 denotes a section of the innovation classification system, while reference numeral 56 denotes a zoomed-in section of the section 53. Contents of the node tree (which implements the innovation classification system) may be viewed by presenting only selected patents 55 without the tree structure 54 and/or patent relevancies. Moving in the tree structure and mapped patents may be accomplished by moving the tree structure within system user interface, as denoted by reference numeral 57.

It is readily apparent to a person skilled in the art that, as the technology advances, the inventive concept can be implemented in various ways. The invention and its embodiments are not limited to the examples described above but may vary within the scope of the claims.

1. A computer-assisted method for supporting organization of innovation documents, comprising:
maintaining a database in a physical storage medium;
storing in the database at least one computer-readable description for each of the following: an innovation classification system, an ontology, a synonym vocabulary and a list of fill words;
storing in the database a plurality of computer-readable innovation descriptions;
receiving a computer-readable innovation document which describes an innovation;
processing the computer-readable innovation document, wherein said processing of the computer-readable innovation document is responsive to said reception of the computer-readable innovation document and comprises:
identifying key words of the computer-readable innovation document by mapping the computer-readable innovation document against the list of fill words;
producing a systematized version of the computer-readable innovation document by mapping the key words of the computer-readable innovation document against the computer-readable synonym vocabulary and the computer-readable ontology;
producing a weighting for each key word of the systematized version of the computer-readable innovation document by mapping its key words against the computer-readable innovation classification system;
determining an optimal placement of the innovation document in the innovation classification system based on the weightings for the key words; and
outputting the optimal placement of the innovation document and at least part of the innovation classification system to a physical output device.

2. The method according to claim 1, wherein the weighting for each key word is at least partially based on a location of the key word within the innovation document.

3. A method according to claim 1, further comprising storing the innovation document in the database as a new innovation description.

4. A method according to claim 1, further comprising determining a degree of correspondence between the innovation document and one or more of the innovation descriptions stored in the database.

5. A method according to claim 4, further comprising retrieving from the database innovation descriptions whose degree of correspondence with the invention document equals of exceeds a predetermined threshold.

6. A method according to claim 4, further comprising retrieving from the database innovation descriptions which meet one or more predetermined filter criteria.

7. A method according to claim 1, further comprising implementing the innovation classification system as a tree structure of nodes connected by connections, wherein the tree structure comprises a root node, several intermediate nodes and several leaf nodes.

8. A method according to claim 7, further comprising mapping the optimal placement of the innovation document to one of the nodes and determining a relevancy for the innovation document by determining nodes which are at most a predetermined number of connections away from the mapped optimal placement of the innovation document.

9. A method according to claim 7, further comprising visualizing the tree structure such that for a node in the tree structure, the node's horizontally or vertically projected distance from the root node indicates a time when the node was inserted into the tree structure.

10. A method according to claim 7, further comprising visualizing the tree structure and attaching a visual indicator to a plurality of the nodes, wherein for a node, the visual indicator attached to the node indicates a number of innovation descriptions for which the node is the optimal placement.

11. A tangible software medium comprising program code instructions for a computer system which includes at least one database, wherein the program code instructions comprise instructions whose execution in the computer system causes the computer system to carry out the method of claim 1.
